(19) United States
(12) Patent Application Publication
(10) Pub. No.: US 2007/0090722 A1
(43) Pub. Date: Apr. 26, 2007

(54) Micro parallel kinematic mechanism design and fabrication

(76) Inventors: Jong-I Mou, Taipei (TW); Chi-Te Chin, HsinChu (TW)

Correspondence Address: CHRISTIE, PARKER & HALE, LLP, PO BOX 7068, PASADENA, CA, 91109-7068, US

(21) Appl. No.: 10/548,852

(22) PCT Filed: Mar. 11, 2004
(86) PCT No.: PCT/US04/07578

§ 371 Date: Jun. 7, 2006

Related U.S. Application Data
(60) Provisional application No. 60/432,886, filed on Mar. 11, 2004.

(51) Int. Cl. H02K 5/00; H02N 1/00

(52) U.S. Cl. 310/309; 310/40 MM

(57) ABSTRACT

A planar micro parallel-link mechanism that provides fine planar motion to a platform in two translation directions and one rotation direction using comb-drive actuators with gear chain systems coupled to rack-and-pinions and struts. The micro parallel-link mechanism has a large operating envelope and can be fabricated using surface micromachining techniques. The kinematic and dynamic analyses of the micro parallel-link mechanism are integrated with closed-loop control system to monitor and supervise the position and velocity of the micro mechanism with three degree-of freedom motions. Methods of depositing and building miniaturized tools and parts on the platform are also disclosed to provide the basic building block for a number of products applicable for nano technology, sensor, actuators, and biotechnology applications.

### CROSS-REFERENCE TO RELATED APPLICATION

This is an ordinary application of provisional application Ser. No. 60/432,886, filed Mar. 11,2003, the contents of which are expressly incorporated herein by reference.

Computer controllable micro parallel-link mechanisms are generally discussed herein with specific discussions extended to micro mechanism micro-fabricated devices or systems of polysilicon having a platform that is driven by comb-drive actuators linked to one or more of gear-trains, rack-and-pinions, and struts for providing fine planar motion in multiple directions.

### BACKGROUND

Integrated micro devices or systems combining electrical and mechanical components can sense, control and actuate on a micro scale level. These devices or systems can function individually or in arrays to generate effects on the macro scale. Applications for micro devices are widely diverse. Included among them are pressure sensors, accelerometers, chemical and flow sensors, fluid pumps and valves, micro relays, optical mirrors and scanners, and mass spectrometers. These devices are finding their way into products such as cars, computers, printers, medical equipment, military ordnance, displays, factories, and consumer products.

Exemplary prior art patents that disclose micro devices or systems, how they are made, and how they are used include U.S. Pat. Nos. 5,205,346 (Tang et al.), 5,955,801 (Romero et al.), 5,631,514 (Garcia et al.), 5,013,693, 5,718,618, 5,866,281, and 5,908,719 (all to Guckel et al.). The contents of these patents are expressly incorporated herein by reference.

In recent years, technology pushes as well as market pull lead to an intensive development of micromachining technologies for the realization of a wide range of industrial process applications. As excellent progress has been made in the development of complex micro electromechanical systems, the development of integrated micro electromechanical systems with more moving parts and dexterity becomes an emerging yet challenging task, which the prior art has not met. Accordingly, there is a need for a computer controllable micro platform with multiple degrees-of-freedom to provide the basic building block to a number of products in manufacturing, sensors, actuators, optical, and biomedical fields, just to name a few. Using surface micromachining process, the designed micro-mechanism build on parallel mechanism technology could give a large operating envelope with a minimum number of microstructure levels and with minimum assembly needs. A developed control environment and user interface could seamlessly integrate the functions of accepting command signals as well as monitoring and controlling the commanded motion of the micro-mechanism in the designated workspace. Deposit miniaturized tools on a micro platform could also be used to advance the state-of-the-art of nano technology.

### SUMMARY

Most modern silicon based micro-fabrication processes cannot accommodate the stacking of actuators necessary for serial-link mechanisms. Therefore, a parallel-link mechanism is seen as a critical design for fabricating a multi-degree of freedom micro-mechanism on a chip and providing the maximum operating envelope with a minimum number of silicon levels.

The embodiments provided in accordance with aspects of the present invention relate generally to computer controllable micro parallel-link mechanisms that is capable of multi-degree of freedom mounted on a chip. More specifically, the embodiments are directed to a micro mechanism micro-fabricated of polysilicon having a platform that may be driven by comb-drive actuators linked to gear-trains, rack-and-pinions, and struts. The arrangement provides fine planar motion in a plurality of directions, including in two translation directions and one rotation direction. Various tools could be attached to the platform for micro and nano technology manipulations. The embodiments provided in accordance with aspects of the present invention are adaptable to applications involving automotive, aviation, biomedical, consumer products, computer mechatronics, defense, manufacturing, and nano engineering, just to name a few.

The present invention may be implemented by providing micro parallel-link mechanism system comprising a first set of moving parts, said first set of moving parts comprising a gear train, a rack-and-pinion set, a strut coupled to a movable platform, and at least one comb actuator for supplying a force to the gear train; and wherein the first set of moving parts are fabricated from polysilicon material on one wafer using surface micromachining fabrication techniques.

In another aspect of the present invention, there is provided a micro parallel-link mechanism system comprising a plurality of interconnected parts including a movable platform connected to three struts, each strut being connected to a rack-and-pinion set, which is connected to a gear train, and which is connected to a pair of comb actuators, and wherein the plurality of interconnected parts are moveable and produce a planar motion and rotation about an axis defined by the movable platform.

In yet another aspect of the present invention, there is provided A method for forming a micro parallel-link mechanism system comprising a plurality of movable parts comprising a movable platform connected to a plurality of micro engines and micromechanisms comprising struts, gear trains, and rack-and-pinion sets, said method comprising the steps of providing a silicon substrate; applying a dielectric layer over the silicon substrate; applying a plurality of masks for generating patterns for the plurality of movable parts; and applying a plurality of polysilicon layers, patterning the polysilicon layers, and etching the polysilicon layers to form shapes of the plurality of movable parts.

### BRIEF DESCRIPTION OF THE DRAWINGS

These and other features and advantages of the present invention will become appreciated as the same become better understood with reference to the specification, claims and appended drawings wherein:

FIG. 1 is a top plan view of a micro parallel mechanism system embodying the principles of the present invention;

FIG. 2 is an illustration of the basic conversion of linear motion to rotational motion;

FIG. 3 is the planar parallel-link mechanism configuration of FIG. 1 shown in system dynamics format;

FIG. 4 is an illustration of a feedback controller diagram of the developed micro parallel-link mechanism system provided in accordance with aspects of the present invention;

FIGS. 5a and 5b are enlarged views showing the linkages between comb-driver beam X and Y, the gear hub, and special pattern through the gear body;

FIG. 6 is another enlarged gear-chain view illustrating the mechanism conversion through small gear to large gear;

FIG. 7 is a subdivision view of a rack-and-pinion set;

FIG. 8 is a sectional view of the linkage between a rotary or triangular platform and part of a rack-and-pinion set;

FIGS. 9a-9n are cross-sectional views of a micro fabrication process on gear linkages between the X and Y comb-driver beams of FIGS. 5a and 5b;

FIGS. 10a-10k are cross-sectional views of a micro fabrication process of the last gear and rack-and-pinion relationship of FIG. 7;

FIGS. 11a-11n are cross-sectional views of a micro fabrication process of the rack-and-pinion stopper of FIG. 7;

FIGS. 12a-12n are cross-sectional views of a micro fabrication process on the platform linkage between the platform and the rack-and-pinion set of FIG. 8;

FIGS. 13a and 13b are concept views of a lift-off process useable herein;

FIG. 14 is a concept of composition of structural material view;

FIG. 15a is a top view of the complete micro parallel mechanism system of FIG. 1 after sacrificial oxide removal while FIG. 15b is an enlarged view of the same;

FIG. 16 is a side view of a metal plate deposited on a platform by metallization process;

FIG. 17 is a side view of a metal structure deposited on a platform by metallization process;

FIG. 18 is a side view of metal blade/tool built on a platform by deep photolithography process and electroplating process with any possible post process such as FIB;

FIG. 19 illustrates a micro electrostatic tweezers application built and controlled from outside environment through wire bonding technology; and

FIG. 20 illustrates a micro thermal bender application built and controlled from outside environment through wire bonding technology.

### DETAILED DESCRIPTION

The detailed description set forth below in connection with the appended drawings is intended as a description of the presently preferred embodiments of a micro mechanism micro-fabricated device or system provided in accordance with practice of the present invention and is not intended to represent the only forms in which the present invention may be constructed or utilized. The description sets forth the features and the steps for constructing and using the micro mechanism micro-fabricated device or system of the present invention in connection with the illustrated embodiments. It is to be understood, however, that the same or equivalent functions and structures may be accomplished by different embodiments that are also intended to be encompassed within the spirit and scope of the invention. Also, as denoted elsewhere herein, like element numbers are intended to indicate like or similar elements or features.

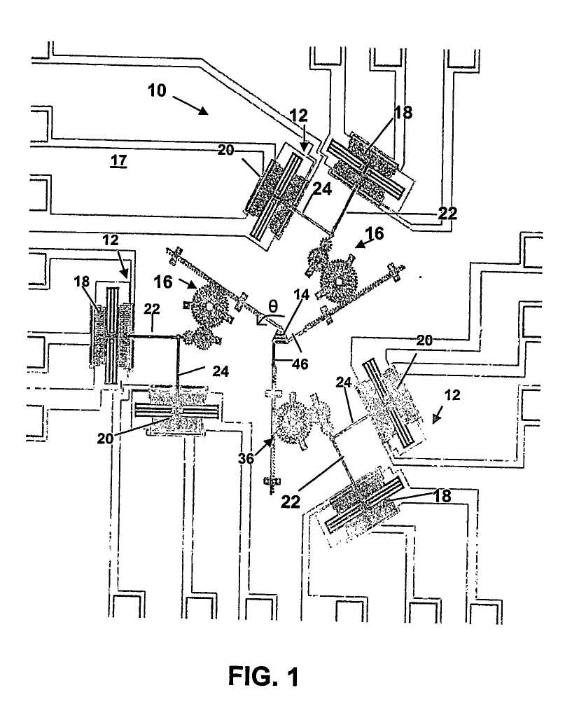

Referring now to FIG. 1, a micro parallel link mechanism system provided in accordance with aspects of the present invention is shown, which is generally designated 10. The system 10 comprises a plurality of micro engines or micro parallel link drive units 12, which in the present preferred embodiment comprises three units, interconnected to a movable platform 14 via a different sets of micromechanisms 16 mounted on a chip 17, as further discussed below. The micro engines 12 in accordance with the first preferred embodiment of the present invention is based in part on the basic micro engine systems created by Garcia et al, which is described in U.S. Pat. No. 5,631,514, and Romero et al, which is described in U.S. Pat. No. 5,955,801, and both are previously incorporated herein by reference. An exemplary basic micro engine 12 and a micromechanism 16 are shown in FIGS. 5a and 5b and further discussed below in greater detail.

Broadly speaking, microelectromechanical systems (MEMS) are mechanical structures that are small in feature size and that perform specialized mechanical functions. Referring again to FIG. 1, in one exemplary embodiment, the MEMS provided in accordance with aspects of the present invention comprises three micro planar parallel mechanisms or micro engines 12 each comprising a plurality of comb drive actuators 18, 20 connected to a triangular or rotary and movable platform 14 for further manipulating, such as for attaching to a micro fool for performing some desired function, for example, e.g., for operating as a micro-milling machine, as a micro hard drive, or as a micro CD player, just to name a few. The system 10 has multi-degrees-of-freedom for planar motion in two translational directions along the x and y axes of a reference coordinate (See, e.g., FIG. 3), and one rotational direction θ about the central axis of the rotary platform 14.

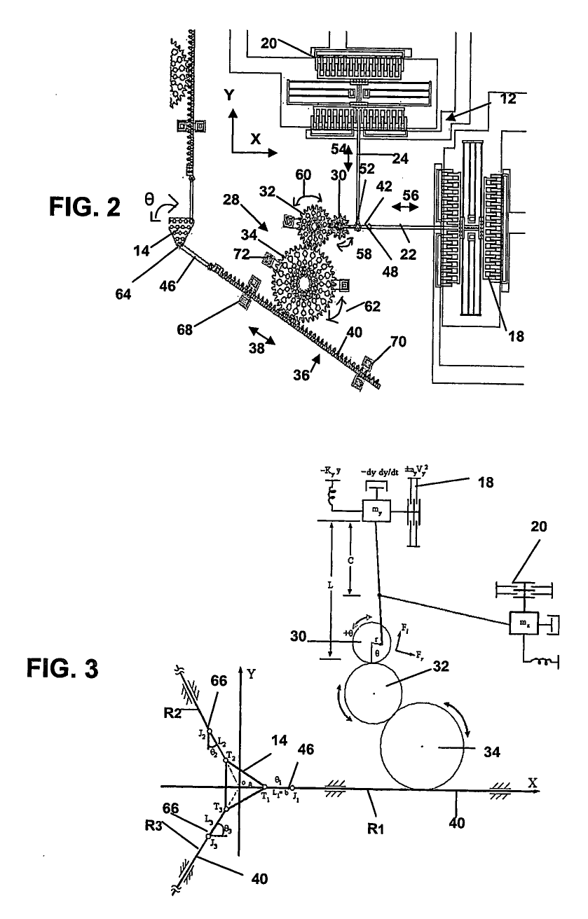

The power source for the micro parallel link mechanism system 10 are from the plurality of micro engines 12, one of which is shown in greater details in FIG. 2. The micro engine 12 uses comb drive actuators 18, 20 as a power source. The comb drive actuators 18, 20 produce linear oscillatory motions as outputs at the linkages 22, 24. The linear oscillatory motions are then converted into rotational motion through a gear train system 28, which comprises an output gear 30 and two load gears 32, 34. The last load gear 34 is then coupled to a rack-and-pinion 36 for finer increments of linear motion 38, in which the elongated gear 40 is the rack and one of the load gears 34 is the pinion. The rotary motor or micro engine 12 and the micromechanism 16 behaves similar to a stepper motor when drive pulses are counted for controlling the rotary motor, which is the basis for a simple open loop control system.

Linear electrostatic comb drive actuators 18, 20 were introduced by Tang et al. and disclosed in U.S. Pat. No. 5,025,346. Accordingly, further discussion of the linear drive actuators is deemed unnecessary. Other linear actuators useable with the present system include electrostatic actuators, electromagnetic actuators, pneumatic actuators, piezoelectric actuators, shape memory alloy actuators, and phase change actuators.

Referring now to FIGS. 5a and 5b in addition to FIGS. 1 and 2, the output gear 30 is rotated by forces applied to it through a linkage 42 (FIG. 5b). The linkage 42 is connected to the output gear 30 via a receiving joint 44 formed as part of the linkage 42 in one micro fabrication step, as further discussed below. The joint and linkage is preferably a one-piece part made by one fabrication step. The receiving joint has dual functions. First it acts as a coaxial hub to align the shaft of the output gear 30 to the linkage 42, and it also acts as a driving hinge for the output gear. By incorporating the receiving joint attachment and by synchronizing the motion of the actuators 18, 20 in the X and Y axes (FIG. 2), the output gear 30 can be made to rotate in a 360° rotation (2π radians) through the continuously synchronized motion of the actuator 18 in the positive or negative X direction and of the actuator 20 in the positive or negative Y direction. The continuous synchronization of the actuators 18, 20 will result in continued rotation of the output gear 30. The output gear 30 can also reverse its rotation by reversing the operation of the actuators 18, 20. The output gear speed can be adjusted by changing the timing of the actuators 18, 20 and by adjusting the amount of power provided to the actuators. The timing changes or controls the actuation frequency while the power adjustment controls the actuation distance. Together, the two can control the rotational speed of the gear.

As is readily apparent to a person of ordinary skill in the art, the rotary motor system 12 (FIG. 2) provides an output in the form of a continuously rotating output gear 30 capable of delivering drive torque to a micromechanism 16. In the presently preferred embodiment, the micromechanism 16 comprises the load gears 32, 34, the rack-and-pinion 36, and a strut 46 (FIG. 2). Each micromechanism 16 connects to the platform 14 via a pin joint 64 (FIG. 8). The motion of the platform 14 is actuated by a set of rotary motor systems 12 and micromechanisms 16. The platform 14 may be used as part of a building block for a number of products applicable for nano technology, sensors, actuators, and biotechnology applications, just to name a few.

In an exemplary embodiment, the drive beam or link 22 of the first actuator 18 is linked to the output gear 30 through a linkage assembly 42 (FIGS. 5a and 5b). More specifically, in one exemplary embodiment, the drive beam 22 along the X direction is connected to the linkage 42 at a first interconnecting link or pin joint 48. The linkage 42 is then connected to the output gear 30 by way of another pin joint 44 on the linkage 42 connecting to the body of the output gear 30 with a preset offset from the retaining hub 50 to drive the motion of the gear 30. The preset offset is similar to a flanged section on the hub 50, as further discussed below. The second actuator 20 is then linked to the linkage mechanism 42 of the first actuator 18. In one exemplary embodiment, this is achieved by interconnecting the drive beam 24 along the Y direction to the linkage mechanism 42 at the second interconnecting link or pin joint 52, which is also a pin joint to allow for motion of the linkages.

The micro parallel-link mechanism system 10 is based on the manufacturability that is achievable with surface micromachining techniques. As discussed above, the micro parallel-link mechanism system 10 consists of a platform 14 that is attached to three micro engines 12 through three struts 46 belonging to three micromechanisms 16 (FIGS. 1 and 2). Each strut 46 is attached to and moved by an individual rack-and-pinion mechanism 36. Referring additionally to FIG. 3, the mobile platform 14 is connected to one end of the three struts 46 having lengths L₁, L₂, and L₃. The other ends of the struts 46 connect to the rack-and-pinion sets 36 where the racks 40 have lengths R₁, R₂, and R₃. The rack and pinion sets 36 are then driven by the gear trains 28 and the comb drives 18, 20. In an exemplary embodiment, the rack-and-pinions 36 and the mobile platform 14 are located on the same plane while the struts 46 are at a level above them. The whole system has three degrees of freedom, including two linear translations and one rotational translation.

The motion of each parallel-link mechanism 12 is constrained by the geometry of the link or strut 46 and rack-and-pinion 36. The kinematics of the system 10 involves the computation of the strut lengths L₁, L₂, L₃ and positions of the strut joints 66 (FIG. 8). If the desired platform location (x, y, θ) is given, the required rack-and-pinion displacement could be determined. For example, denote the mobile platform center position with respect to the reference coordinate system depicted in FIG. 3 by [x, y]. Now, let θ represent the rotation angle which is measured in a right-hand coordinate and the distances from the mobile platform center to three vertices T₁, T₂ and T₃ (FIG. 3) is a and the length of the three struts is b. As the initial mobile platform position is set, where the coordinate [x, y] of the platform center respect to the reference coordinate is [0,0] and θ=0, the coordinates of the three vertices T₁, T₂, and T₃ can be derived.

The relationship between the platform coordinate system and the reference coordinate system can be expressed by the mobile platform's location (position [x, y] and orientation θ). As the mobile platform's location is given, the three vertices coordinates are infer as follows:

$$[ \begin{matrix}{X}_{T 1} & {Y}_{T 1} & 1 \\ {X}_{T 2} & {Y}_{T 2} & 1 \\ {X}_{T 3} & {Y}_{T 3} & 1\end{matrix} ] [ \begin{matrix}cos θ & sin θ & 0 \\ - sin θ & cos θ & 0 \\ X & Y & 1\end{matrix} ] = [ \begin{matrix}{}_{}^{B}{X}{}_{T 1}^{} & {}_{}^{B}{Y}{}_{T 1}^{} & 1 \\ {}_{}^{B}{X}{}_{T 2}^{} & {}_{}^{B}{Y}{}_{T 2}^{} & 1 \\ {}_{}^{B}{X}{}_{T 3}^{} & {}_{}^{B}{Y}{}_{T 3}^{} & 1\end{matrix} ] \qquad ( 1 )$$

The coordinates of the center of the three strut joints relative to the origin of the base coordinate system can be expressed as follows:
J₁=└^{B}X_{J1},^{B}Y_{J1}┘; J₂=└^{B}X_{J2},^{B}Y_{J2}┘; J₃=└^{B}X_{J3},^{B}Y_{J3}┘
where N and M are geometric scale factor; ^{B}Y_{J1}=0; ^{B}Y_{J2}=N^{B}X_{J2}; ^{B}Y_{J3}=M^{B}X_{J3}.

The distance between each pair of the joint center and the platform vertex is the length of the strut, b. Thus, unique solution of the inverse kinematics can be derived.
(^{B}X_{T1}−^{B}X_{J1})²+(^{B}Y_{T1}−^{B}Y_{J1})²=b²
(^{B}X_{T2}−^{B}X_{J2})²+(^{B}Y_{T2}−^{B}Y_{J2})²=b²
(^{B}X_{T3}−^{B}X_{J3})²+(^{B}Y_{T3}−^{B}Y_{J3})²=b² (2)

Several forces are considered when modeling the dynamics of the micro engine. Optimized electrical drive signals for micro engine can be derived from simple Newtonian physics. They account for the electrostatic force of the comb drives, the restoring force of the folded comb drive springs, and the damping force associated with air damping. Furthermore, tangential and radial forces at the gear are included. To simplify the derivation, the following terms are defined:

$$γ = \frac{C}{L} ; {δ}_{i} = \frac{{d}_{i}}{2 {m}_{i}} ; {ω}_{n , i} = \sqrt{\frac{{k}_{i}}{{m}_{i}}} ; ( i = x , y ) .$$

where C and L are geometrical quantities; mᵢ, kᵢ, and ω_{n,i} are the mass, spring constant, resonant frequency of the structure moving in the i direction, respectively. By solving the Newton's equation ΣF=ma, yields

$$\begin{matrix}{V}_{x}^{2} = \frac{1}{γ} \frac{kr}{a} \{ \frac{{γ}^{2}}{{ω}_{n , x}^{2}} [ ( \ddot{θ} + 2 {δ}_{x} \dot{θ} ) cos ( θ ) - {\dot{θ}}^{2} sin θ ] + ( \frac{{F}_{r}}{kr} + {γ}^{2} ) sin θ + \frac{{F}_{l}}{kr} cos θ \} & ( 3 ) \\ {V}_{y}^{2} = \frac{kr}{a} \{ \frac{1}{{ω}_{n , y}^{2}} [ ( \ddot{θ} + 2 δ \dot{θ} ) sin ( θ ) + {\dot{θ}}^{2} cos θ ] + 1 - ( \frac{{F}_{r}}{kr} + 1 ) cos θ + \frac{{F}_{l}}{kr} sin θ \} & ( 4 )\end{matrix}$$

where Vₓ and V_{y} are x voltage (right and left) and y voltage (up and down), respectively, a is the electrostatic force constant associated with the comb drive, k is the common spring constant (kₓ=k_{y}). The radius of the gear is represented by r and the radial and tangential forces on the gear are Fᵣ and Fₗ, respectively. The term γ is a geometric term that represents the coupling location of the two linkage arms. The gear angle, angular velocity and angular acceleration are given by θ,\dot{θ}, and \ddot{θ}, respectively.

A third-order nonlinear dynamical model is derived for the micro parallel-link mechanism as follows.
\dot{x}ₚ=F(xₚ,uₚ) yₚ=Cxₚ
where the control vector uₚεR^{2x1}, the state vector xₚεR^{2x1}, and the output vector yₚεR^{1x1} are defined as follows:

$$\begin{matrix}{u}_{p} = [ \begin{matrix}{V}_{x} = x axis drive signal ( V ) \\ {V}_{y} = y axis drive signal ( V )\end{matrix} ] \\ {x}_{p} = [ \begin{matrix}θ = angular position ( deg ) \\ ω = angular velocity ( deg / sec )\end{matrix} ]\end{matrix}$$

Linearizing the micro parallel-link mechanism about the equilibrium point xₚ=0 and uₚ=0 (i.e., all states and control force equal to zero), results in the following linear state space representation.
\dot{x}ₚ=Aₚxₚ+Bₚuₚ
yₚ=Cₚxₚ
where AₚεR^{2x2}, BₚεR^{2x2}, and CₚεR^{1x2} represent small perturbations with respect to equilibrium values. From equation (3) and (4), yields

$$\dot{ω} [ \frac{kr}{a} \frac{{γ}^{2}}{{ω}_{n , x}^{2}} cos ( θ ) + \frac{kr}{a} \frac{1}{{ω}_{n , y}^{2}} sin ( θ ) ] = - \frac{kr}{a} \frac{{γ}^{2}}{{ω}_{n , x}^{2}} ( 2 {δ}_{x} ω cos ( θ ) - {ω}^{2} sin ( θ ) ) - sin ( θ ) ( \frac{{F}_{r}}{a} + \frac{kr {γ}^{2}}{a} + \frac{{F}_{l}}{a} ) - \frac{kr}{a} \frac{1}{{ω}_{n , y}^{2}} ( 2 {δ}_{y} ω sin ( θ ) + {ω}^{2} cos ( θ ) ) - cos ( θ ) ( \frac{{F}_{l}}{a} - \frac{{F}_{r}}{a} - \frac{kr}{a} ) - \frac{kr}{a} + γ {V}_{x}^{2} + {V}_{y}^{2} \qquad ( 5 )$$

where \dot{θ}=ω

Since equilibrium point θ≈0, sin(θ)=θ, and

$$cos ( θ ) = 1 - \frac{1}{2} {θ}^{2} .$$

By setting vₓ=Vₓ² and v_{y}=V_{y}², equation (5) can be expressed as follows:

$$\begin{matrix}\dot{θ} = ω \text{=>} {f}_{1} & ( 6 ) \\ \dot{ω} [ \frac{kr}{a} \frac{{γ}^{2}}{{ω}_{n , x}^{2}} ( 1 - \frac{1}{2} {θ}^{2} ) + \frac{kr}{a} \frac{1}{{ω}_{n , y}^{2}} θ ] = - \frac{kr}{a} \frac{{γ}^{2}}{{ω}_{n , x}^{2}} [ 2 {δ}_{x} ω ( 1 - \frac{1}{2} {θ}^{2} ) - {ω}^{2} θ ] - θ ( \frac{{F}_{r}}{a} + \frac{kr {γ}^{2}}{a} + \frac{{F}_{l}}{a} ) - \frac{kr}{a} \frac{1}{{ω}_{n , y}^{2}} [ 2 {δ}_{y} ωθ + {ω}^{2} ( 1 - \frac{1}{2} {θ}^{2} ) ] - ( 1 - \frac{1}{2} {θ}^{2} ) ( \frac{{F}_{l}}{a} - \frac{{F}_{r}}{a} - \frac{kr}{a} ) - \frac{kr}{a} + γ {v}_{x} + {v}_{y \\} \\ \text{=>} {f}_{2} & ( 7 )\end{matrix}$$

Let's \dot{x}=f(x,u), where function f is time-invariant. For constant u=u*, x* is an equilibrium state if f(x*,u*)=0. If x=x* and u=u*, then \dot{x}=0 and the state remains at x*. The dc steady-state quantities satisfies f(x*,u*)=0. Let x(t)=x*+Δx(t), u(t)=u*+Δu(t), \dot{x}*=0, Δ\dot{x}=f(x*+Δx,u*+Δu). Expanding the components of f in a Taylor series and omitting the higher-order terms with f(x*,u*)=0, yields

$$Δ \dot{x} = \frac{\partial f}{\partial x} \vert * Δ x + \frac{\partial f}{\partial u} \vert * Δ u$$

At equilibrium point, vₓ=v_{y}=θ=ω=0.

$$\frac{\partial f}{\partial x} = [ \begin{matrix}\frac{\partial {f}_{1}}{\partial θ} & \frac{\partial {f}_{1}}{\partial ω} \\ \frac{\partial {f}_{2}}{\partial θ} & \frac{\partial {f}_{2}}{\partial ω}\end{matrix} ] \frac{\partial f}{\partial u} = [ \begin{matrix}\frac{\partial {f}_{1}}{\partial {v}_{x}} & \frac{\partial {f}_{1}}{\partial {v}_{y}} \\ \frac{\partial {f}_{2}}{\partial {v}_{x}} & \frac{\partial {f}_{2}}{\partial {v}_{y}}\end{matrix} ]$$

$$where \frac{\partial {f}_{1}}{\partial θ} = 0 , \frac{\partial {f}_{1}}{\partial ω} = 1 , \frac{\partial {f}_{2}}{\partial θ} = - \frac{( {F}_{r} + kr {γ}^{2} + {F}_{l} ) {ω}_{n , x}^{2}}{kr {γ}^{2}} + \frac{( {F}_{l} - {F}_{r} ) {ω}_{n , x}^{4}}{{ω}_{n , y}^{2} kr {γ}^{4}} , \frac{\partial {f}_{2}}{\partial w} = - 2 {δ}_{x} , \frac{\partial {f}_{1}}{\partial {v}_{x}} = \frac{\partial {f}_{1}}{\partial {v}_{y}} = 0 , \frac{\partial {f}_{2}}{\partial {v}_{x}} = \frac{a {ω}_{n , x}^{2}}{kr γ} , \frac{\partial {f}_{2}}{\partial {v}_{y}} = \frac{a {ω}_{n , x}^{2}}{kr {γ}^{2}} .$$

Using nominal parameters, yields

$$\begin{matrix}{A}_{p} = [ \begin{matrix}0 & 1 \\ \frac{- ( {γ}^{2} + ( {F}_{l} + Fr ) / kr ) {ω}_{n , x}^{2}}{{γ}^{2}} + \frac{( ( {F}_{l} - {F}_{r} ) / kr ) {ω}_{n , x}^{4}}{{γ}^{4} {ω}_{n , y}^{2}} & - 2 {δ}_{x}\end{matrix} ] , \\ {B}_{p} = [ \begin{matrix}0 & 0 \\ \frac{a {ω}_{n , x}^{2}}{kr γ} & \frac{a {ω}_{n , x}^{2}}{kr {γ}^{2}}\end{matrix} ] , \\ {C}_{p} = [ \begin{matrix}1 & 0 ] .\end{matrix}\end{matrix}$$

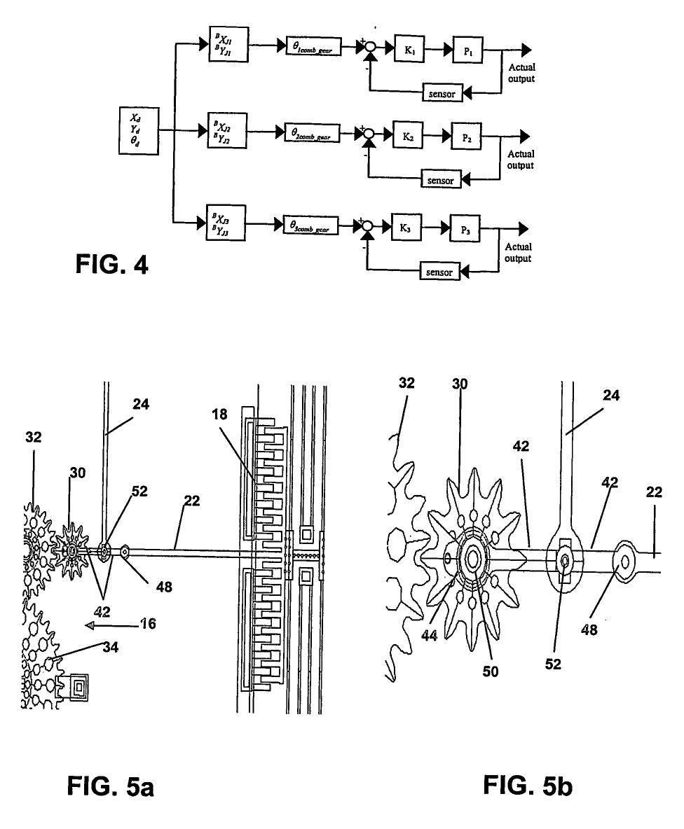

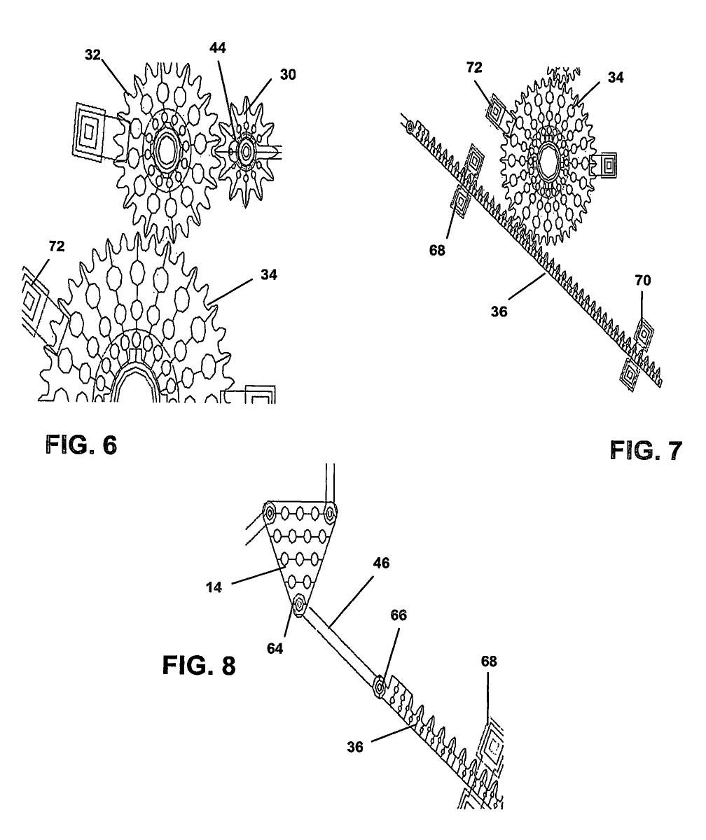

As the desired location (x, y, θ) of the mobile platform is given for a specific motion control, the coordinates of the center of the six strut joints relative to the origin of the base coordinate system are obtained by deriving the unique solution of the inverse kinematics equation. The six strut joints are located at each end of the three struts 46. By specifying the gear ratio, the required rotational angle of each comb drive corresponding to the desired linear displacement of each strut can be determined. FIG. 4 shows an exemplary feedback controller block diagram of the micro parallel-link mechanism based on the foregoing described algorithms.

In one exemplary embodiment, the entire micro parallel mechanism system 10 is fabricated of polysilicon (or other suitable materials) on one wafer using surface micromachining fabrication techniques. In the presently preferred parallel mechanism system 10 using single-sided wafer, nine masks are used. Multiple polysilicon films work as structure layer with intervening sacrificial silicon dioxide films to support the designed structure. The fabrication processes are repetitive deposited layer by layer with critical issue photolithography (mask pattern) techniques. Phosphorous source doping and annealing processes will be applied to the deposited films to obtain proper etching rate, electrical properties, and stress released.

As discussed above, the system 10 utilizes, among other things, a drive gear 30 connected to a linkage 42 via a pin joint 44 and to several links 22, 24, which produce rotational or linear motion to a the load gears 32, 34, to the rack-and-pinion 36, and to the platform 14. The motions are illustrated by the arrow directions 38, 54-62, and θ in FIG. 2. However, the fabrication of the mechanism with gears and links by using surface micromachining techniques presents several fundamental difficulties. In general, these difficulties are due to the vertical topography (out of the plane of the structural elements) introduced by the deposition and etching of various films used. If improper design or fabrication occurs, interference could arise when the interconnecting links 42, 52 pass over the gear 30 or the retaining hub 50 of the gear 30 to provide a complete rotational motion cycle due to the extremely tight operation specifications.

The present mechanism and fabrication process described herein alleviate such potential link/gear interferences that may occur with normal films deposition processes used in surface micromachining. More specifically, the unique positioning and layout of the links 22, 24, 42, the gear hub 50, and the gear 30 accomplish non-interfering rotary motion during the patterning and etching of various deposited films. The same design concept may also be applied to the strut 46 between the platform 14 and the rack-and-pinion 36 with respect to the topography of platform pin joint 64 and rack-and-pinion pin joint 66 (FIG. 8). The guide structures or stoppers 68, 70 (FIG. 7) function as a stopper to guide the rack-and pinion 36 moving along the desired direction.

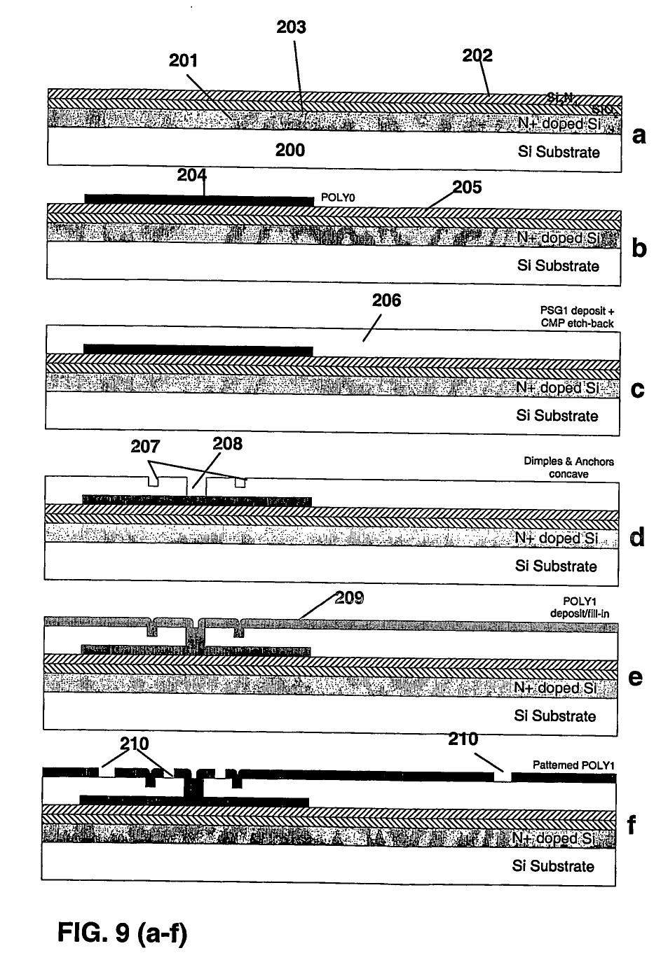

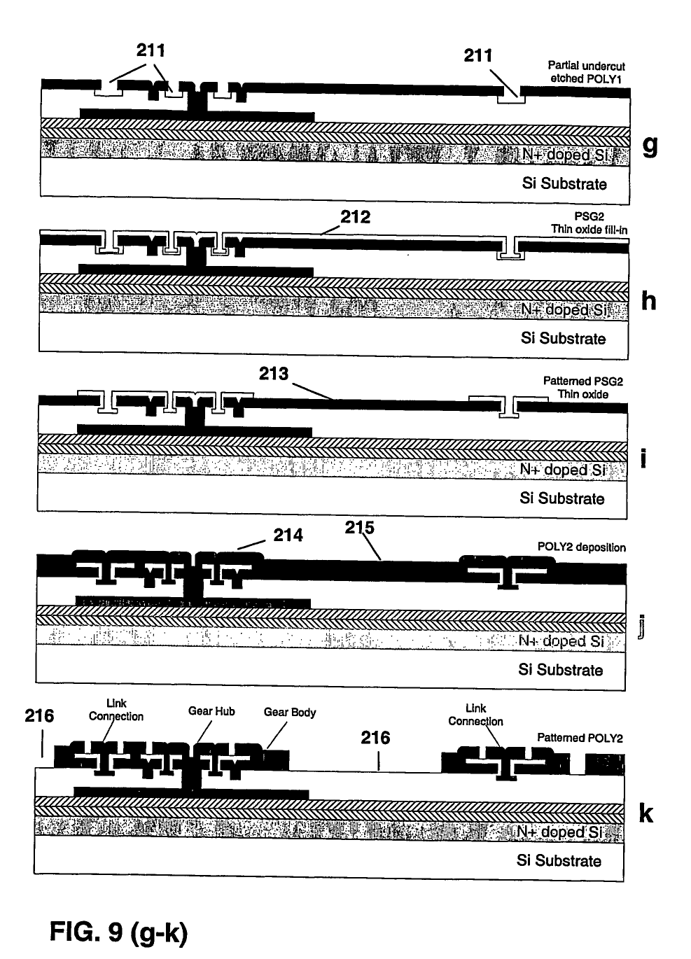

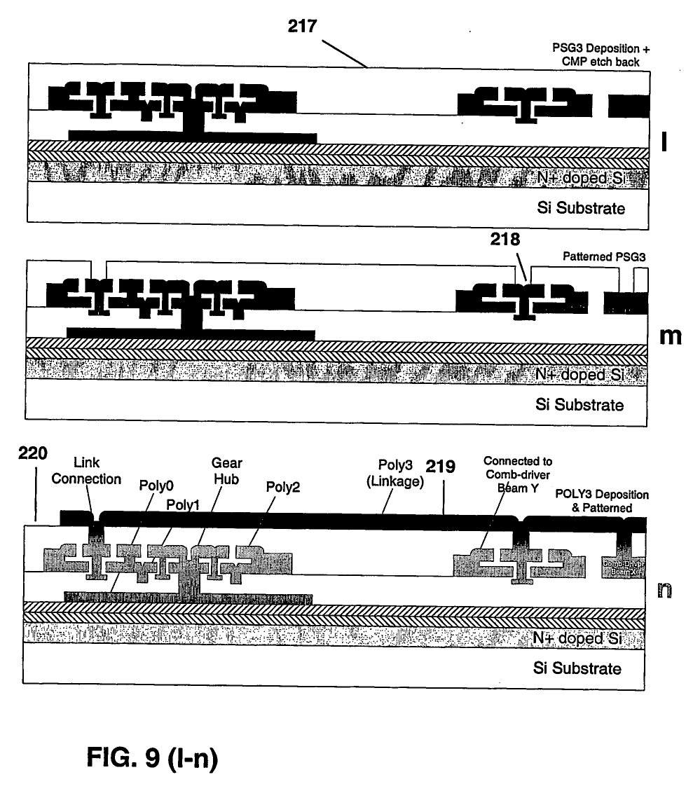

The fabrication of the micro parallel mechanism system including the electrostatic comb drives 18, 20, the power output gears 30, the rack-and-pinion stoppers 68, 70 (FIG. 2), platform linkages or struts 46, and the interconnecting linkages 42 require three depositions of mechanical construction polysilicon, as illustrated in FIGS. 9n, 11n and 12n, and one deposition of electrical interconnect polysilicon. The electrical polysilicon, referred to as POLY0, provides a voltage reference plane and serves as an electrical interconnect layer. The first, second, and third mechanical polysilicon films are referred to as POLY1, POLY2, and POLY3, respectively.

Referring now to FIGS. 9a, 10a, 11a and 12a for producing different parts of the micro parallel mechanism system 10, the steps begin with a 100 mm n-type (100) silicon substrates 200. The surfaces of the substrates or wafers are first heavily doped 201 with phosphorus in a standard diffusion furnace using phosphorus oxychloride (POCl₃) as the dopant source. This step reduces or prevents charge feed through to the substrate from electrostatic devices on the surface. The silicon substrates 200 are coated with dielectric isolation films of Low Pressure Chemical Vapor Deposition (LPCVD) silicon-rich nitride 202 at about 4000 Å thickness over a thermal oxide 203 at about 5000 Å thickness, which acts as a blanket starting point. The blanket isolation films 203 ensure that proper electrical isolation is established between the electrically inducible microstructures and the conductive substrates 200

Referring to FIGS. 9b, 10b, 11b and 12b, the first polysilicon layer 204 (POLY0) is deposited, patterned and etched 205 on each referred figure, which is the electrical interconnect and shield polysilicon, referred to as POLY0. This film 204 is preferably not implemented for structural integrity and therefore may be kept relatively thin, e.g., about 5000 Å thickness. All polysilicon depositions should be LPCVD at about 580° C. to generate find-grained polycrystalline silicon. After the POLY0 layer 204 is deposited on top of the silicon-rich nitride layer 202, it is followed with a heavily phosphorus oxychloride (POCl₃) doped and drive-in process to lower the polysilicon resistivity and stress, as typically used in electrical interconnects. Photolithography pattern techniques and reactive ion etch (RIE) are then used to shape the POLY0 electrical interconnect layer by applying a first mask.

Referring to FIGS. 9c, 10c, 11c and 12c, plasma-enhanced chemical vapor deposition (PECVD) is used to deposit the first thick (e.g., about 3 μm) PSG1 (phosphosilicate glass, or phosphorus-doped SiO₂) sacrificial film 206 on the POLY0 layer 204. PSG has a relatively fast etching rate compared to bare SiO₂ film when it is dissolved in hydrofluoric acid (HF) solution. To ensure uniform topography, chemical mechanical polishing (CMP) technique is used to planarize the PSG films 206 before following with additional polysilicon layer deposition.

The CMP technique permits the thickness of each layer of deposited material to be precisely adjusted and to maintain a planar topography during build up of the designed structure. Without the CMP process, stingers occur as a result of anisotropic etching (e.g. reactive ion etching) and could cause mechanical interference during movement of the structures formed in adjacent polysilicon layers. This in turn can lead to malfunction of the linkages between the actuators and the output gears of the micro engines 12 and the micromechanisms 16. In the disclosed process, a 1 μm PSG1 etch back process is achieved by applying CMP techniques. Therefore, the thickness of the planarized PSG1 layer 206 on the POLY0 layer 204 is about 2 μm.

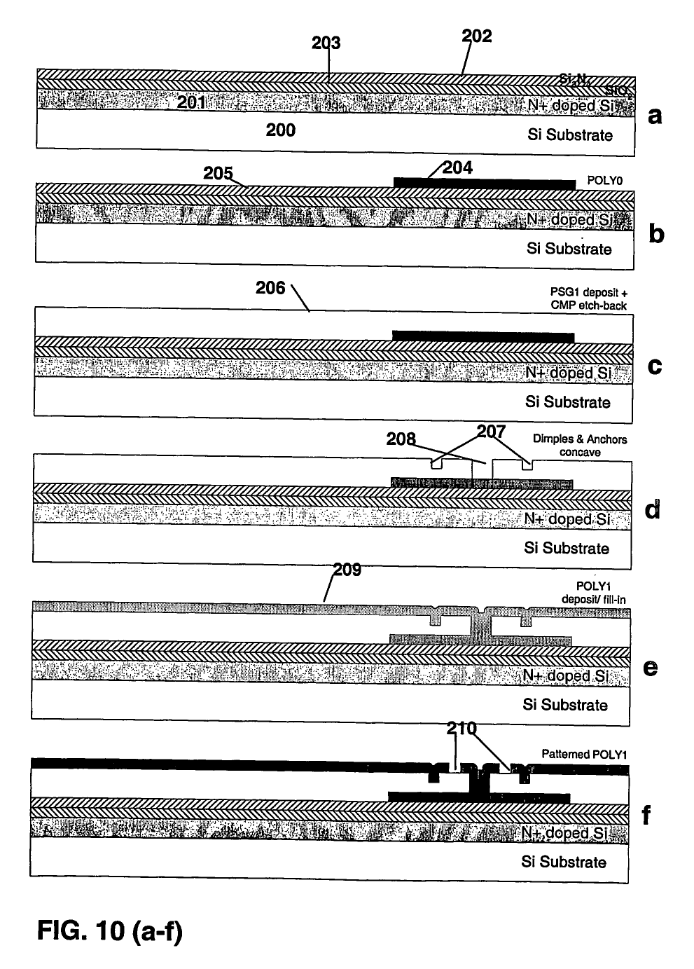

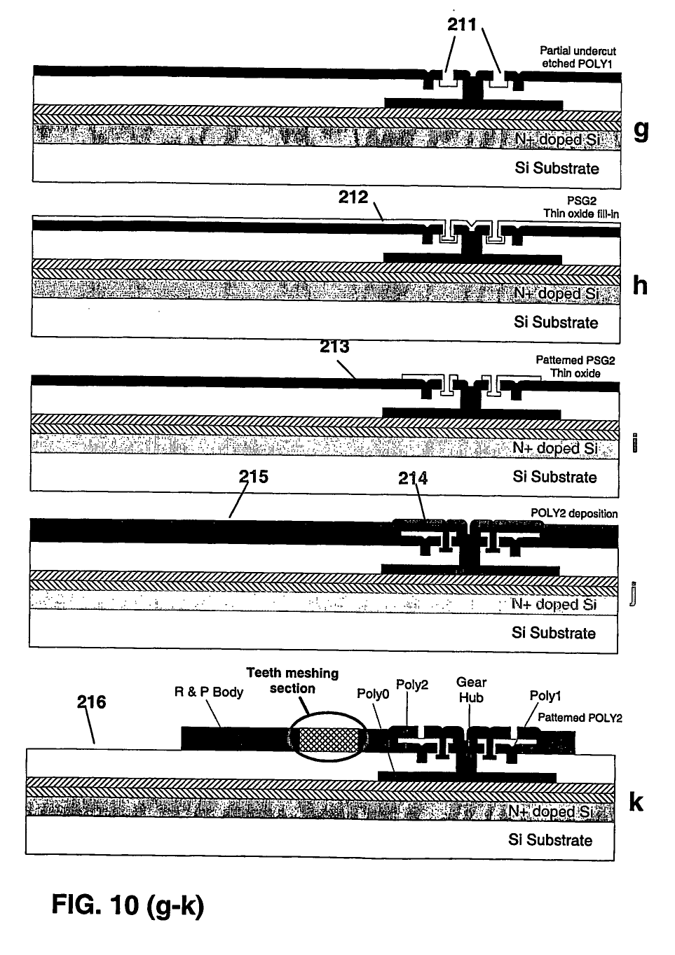

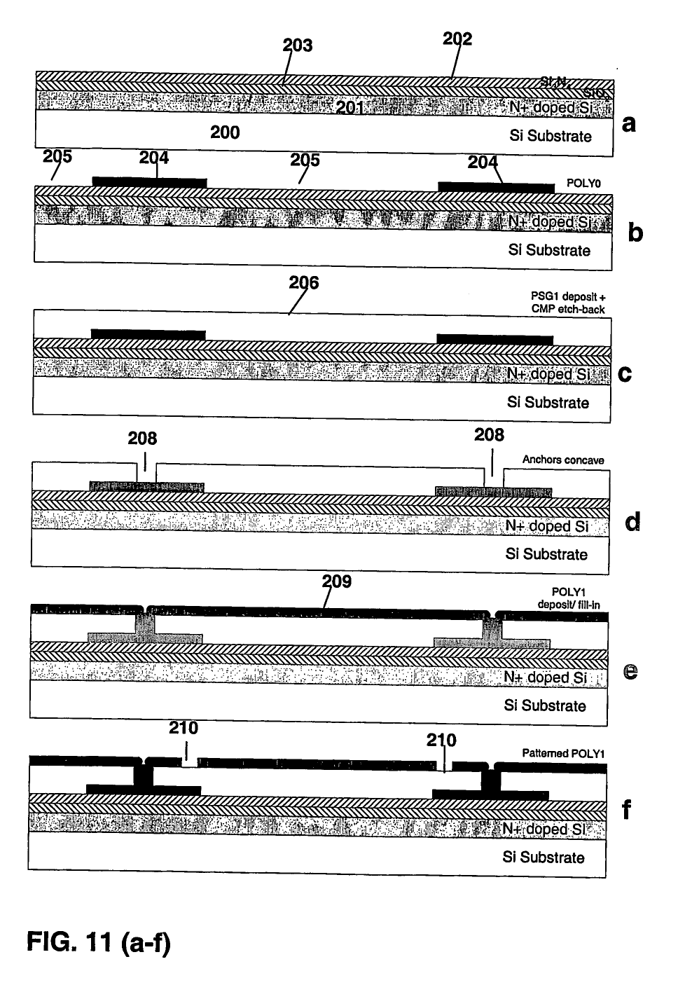

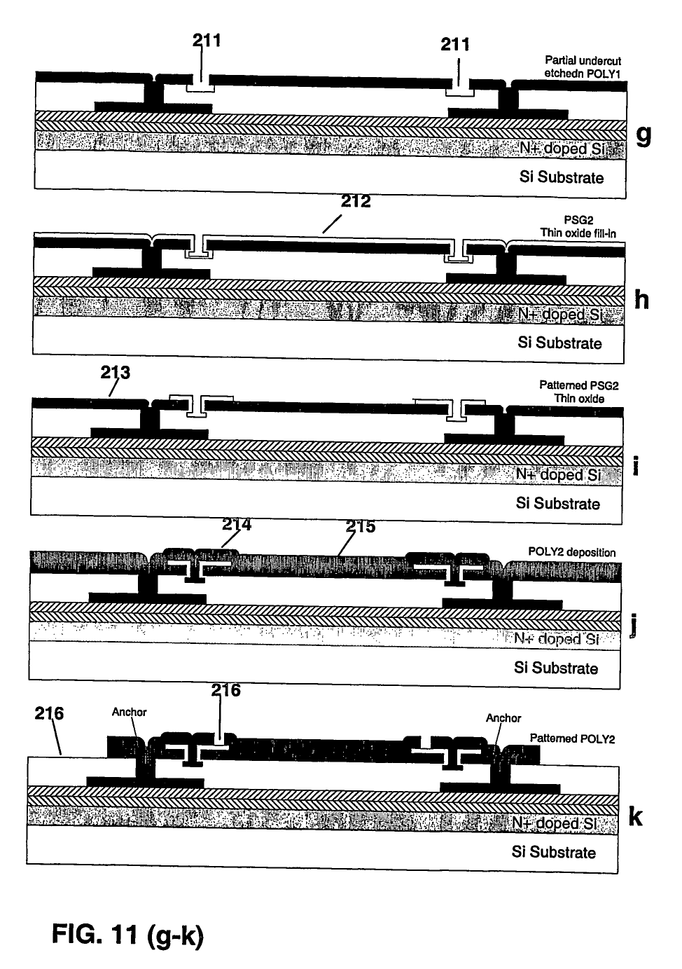

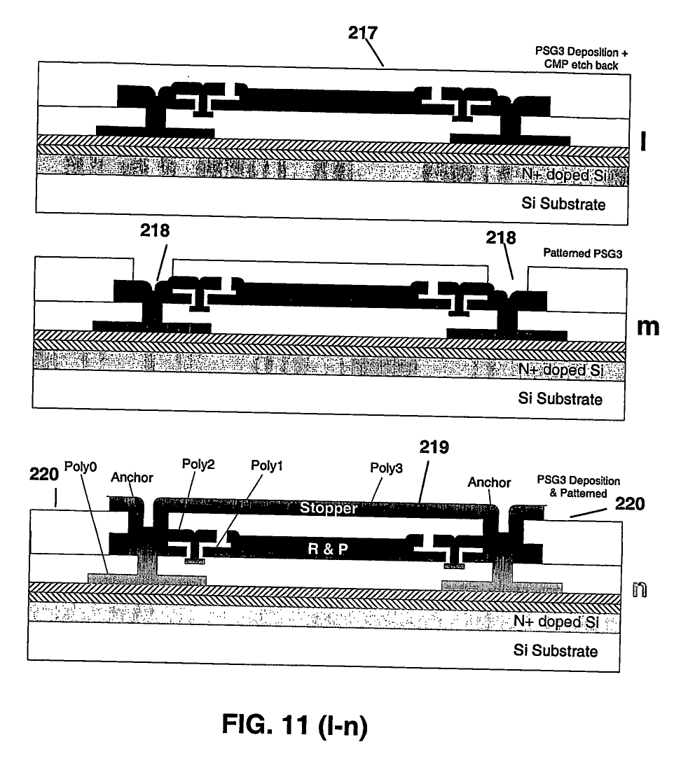

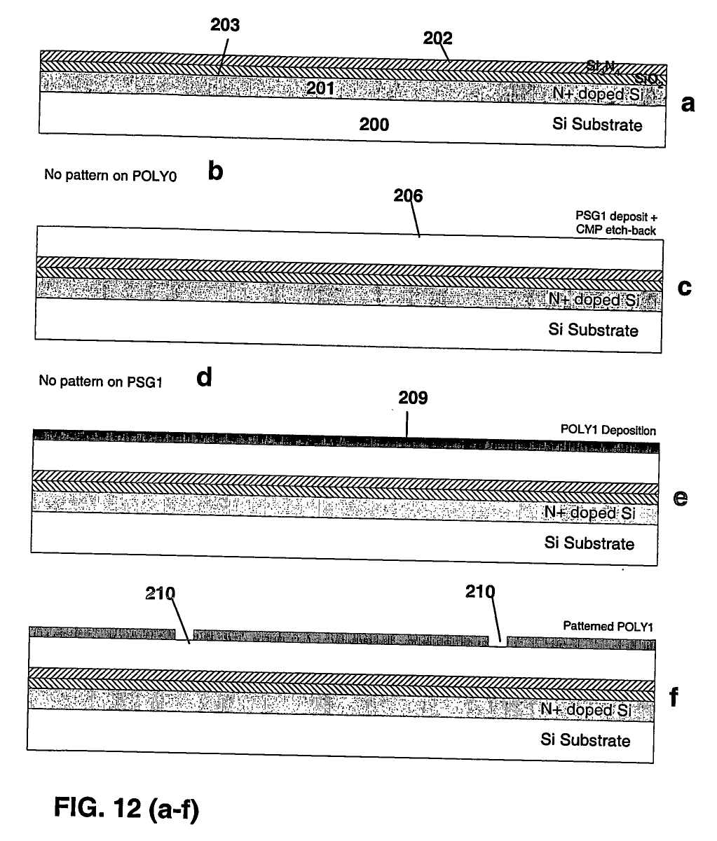

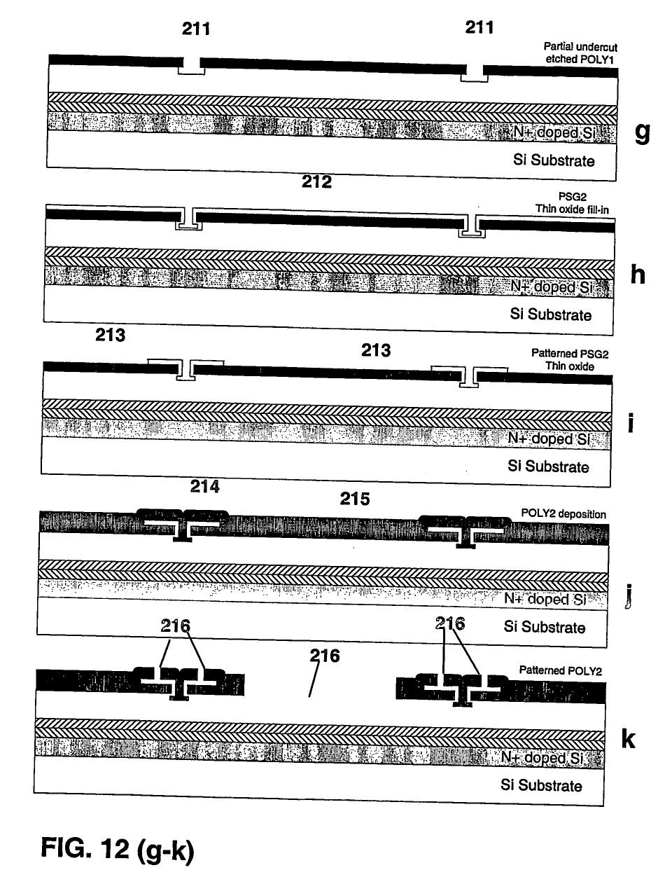

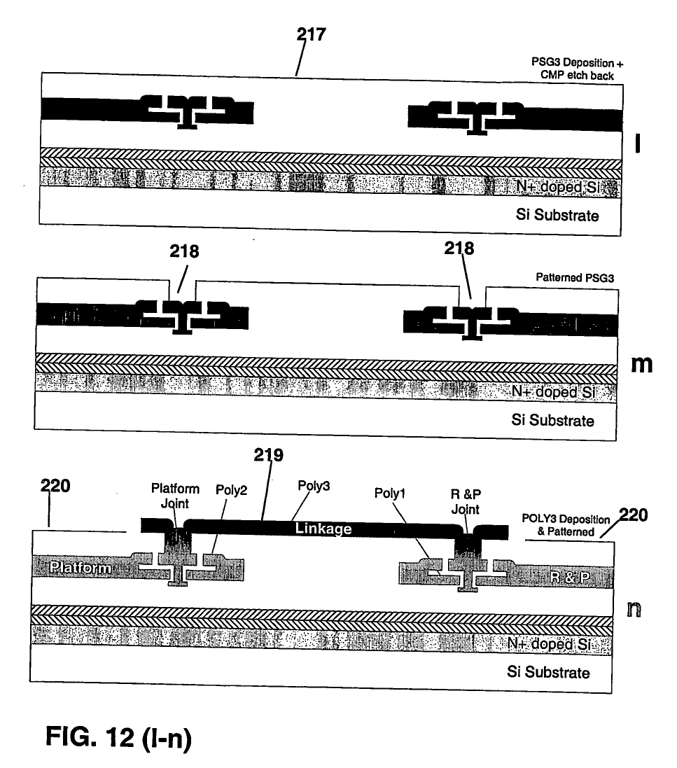

Referring to FIGS. 9d, 10d, 11d and 12d, after the planarized PSG1 layer 206 goes through pre-annealing reflow process at 950° C. in N₂ ambience for about one hour, a second mask is applied to pattern the PSG layer 206 to form ‘dimple’ concaves 207 (FIG. 9d and FIG. 10d) under the upcoming gear body patterned. This step is preferred to avoid stiction problem as it produces small features or bumps on the surface of MEMS devices to reduce contact areas between the top and bottom MEMS structures/layers. In a preferred embodiment, no dimple concaves are needed for the anchor stoppers 68, 70, 72, which are non moving parts, and for the platform linkage 46, which is a second layer structure, shown in FIG. 2. However, concaves may be incorporated if desired. No dimple concaves are needed in the process shown in FIG. 11d and FIG. 12d for the upper layer structures. In the present embodiment, the dimple mode bushings are about 0.70 μm deep down on the PSG1 films 206 in order to provide the anti-stiction effect. This patterning procedure may then be applied again to form ‘anchor’ concaves 208 (FIGS. 9d, 10d and 11d) with the purpose of generating anchor structure after the next POLY1 layer deposition by using a third mask. Again, in a preferred embodiment, no anchor concaves are needed for the platform linkage 46.

Referring to FIGS. 9e, 10e, 11e and 12e, a subsequent polysilicon film 209 (POLY1) is deposited at about 1 μm in thickness. This step fills in the anchor 208 and dimple 207 mold areas to provide attachment for the structure anchors to the substrate, and to form ‘dimples’ on the otherwise flat underside of the polysilicon for stiction reduction. In the present embodiment, the polysilicon film 209 is heavily doped by diffusion of the phosphorus oxychloride (POCl₃) dopant releases from top and bottom PSG layers in subsequent fabrication steps, then annealed at a high temperature of about 950° C. in N₂ ambience for about 3 hours. This step produces a layer 209 with low stress and higher electrical conductivity qualities. In other words, the diffusion and annealing steps are applied to the deposited polysilicon films 209 to obtain higher electrical conductivity and stress release.

The comb drives 18, 20, gears 30, 32, 34, rack-and-pinion 36, and platform 14 (FIG. 2) are all constructed from the first 204 and second 209 polysilicon layers (POLY0 and POLY1). As further discussed below, the drive beam X and beam Y, 22, 24, interconnecting links 42, and platform linkages 46 are formed from a composition comprising three construction poly films. Sacrificial glass layers should be used between all polysilicon levels.

Referring to FIGS. 9f, 10f, 11f and 12f, the substrate anchor for the flanged restraining hub 50 (FIG. 5b) for each of the gears 30, 32, 34 (FIG. 5a) is formed from the POLY1 layer deposition with the restraining hub 50 being formed by a process in which the POLY1 layer 209 is deposited, patterned and etched 210 with a fourth mask, as illustrated in FIGS. 9f and 10f. In this POLY1 patterned and etched 210 process, the substrate anchor for the rack-and-pinion stopper 68, and gear stopper 72 (FIG. 7) are illustrated in FIG. 11f while the platform linkages 64, 66 (FIG. 8) are illustrated in FIG. 12f.

Referring to FIGS. 9g, 10g, 11g and 12g, partial undercut etch 211 of the sacrificial glass under the POLY1 layer is performed to form the basis 211 for a flanged hub, which is part of the restraining hub 50, the rack-and-pinion flanged stopper 68, 70 (FIG. 7), and the linkage joint flanges 64, 66 (FIG. 8). The flanged hub is incorporated to keep the gear body in suspension when rotates. The restraining hub joint 50 and link connections 22, 24, 42 to the comb drives 18, 20 (not shown) and the output gears 30 are of the flanged typed and may be formed by a process similar to and described by Mehregany et al., “Friction and Wear in Microfabricated harmonic Side-Device Motors,” A Solid State Sensor and Actuator Workshop, Hilton Head Island, S.C., June 4-7, IEEE Catalogue No. 90CH2783-9, pages 17-22. Only those areas where the polysilicon layer needs to be undercut to form flanges should be opened. If carried out in this preferred manner, no additional mask level is needed as the polysilicon layer will be its own mask.

Referring to FIGS. 9h, 10h, 11h and 12h, the previous mentioned partial undercut is backfilled by a thin (in the order of ≦0.5 μm) oxide deposition 212 (PSG2) to form the spacing between the restraining hub anchor 50, the gears 30, 32, 34, and the link joints 44, 48, 52. After the PSG2 layer 212, pre-annealing reflow process is carried out at about 950° C. in N₂ ambience for about one hour. The resultant oxide is then patterned and etched 213 by a fifth mask only in the joint and bearing areas, as illustrated in FIGS. 9i, 10i, 11i and 12i. At this point, the POLY2 layer 214 is deposited. The polysilicon deposition is conformal—meaning that it uniformly coats any surface including backfilling the flange undercut.

Referring to FIGS. 9j, 10j, 11j and 12j, after about a 1.5 μm POLY2 layer deposition 214, the gear body, rack-and-pinion body 36, platform body 14, parts of the links, and the comb drives 18, 20 comprise a single layer 215 having a combined composition of POLY1 and POLY2. The composite polysilicon layer 215 is patterned and etched 216, as illustrated in FIGS. 9k, 10k, 11k and 12k with a sixth mask. At this stage, the gears 32, 34 and rack-and-pinion 36 (FIG. 2) are generated. These parts do not require additional patterning, as illustrated in FIG. 10k. The deposition sequences and stated dimensions produce nearly planar surfaces over the gears 30, 32, 34 and the joints 44, 48, 52 64, 66. This permits non-interference of the gear/link assembly during operation.

Referring to FIGS. 9l, 11l and 12l, after of the definition with the sixth mask, the second sacrificial glass layer PSG3 217 is deposited to a thickness on the order of about 2 micron. In a preferred embodiment, this is implemented by depositing about a 5 μm layer and then etched back about 3 μm by a CMP process to produce a flat PSG3 layer of about 2 μm.

Referring to FIGS. 9m, 11m and 12m, after the PSG3 layer 217 is deposited, pre-annealing reflow process is performed at about 950° C. in N₂ ambience for about one hour. A seventh mask is then applied to define all the areas 218 for a POLY3 layer 219 to form the final link structure 42, 46 (FIGS. 5b and 8). The deposited link structure is patterned and etched 220 using an eight mask to achieve the design dimensions and connect the entire assembly as illustrated in FIGS. 9n, 11n and 12n.

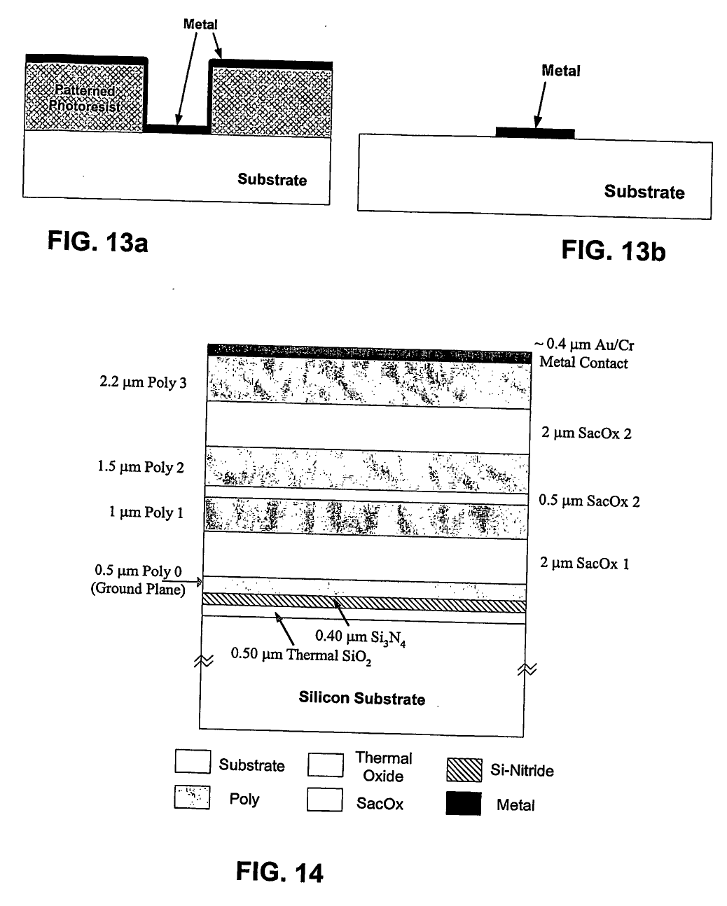

The lift-off process shown in FIGS. 13a and 13b is used to generate metal contact region (e.g., aluminum or others metal). FIG. 13a illustrates the photoresist-patterned process by a ninth mask followed by a metal deposition process. FIG. 13b demonstrates the metal contact left by applying ultrasonic vibrate technique to lift-off un-patterned region metal.

Referring to FIG. 14, the composition of alternating layers of polysilicon and sacrificial oxide used in the presently preferred process is listed.

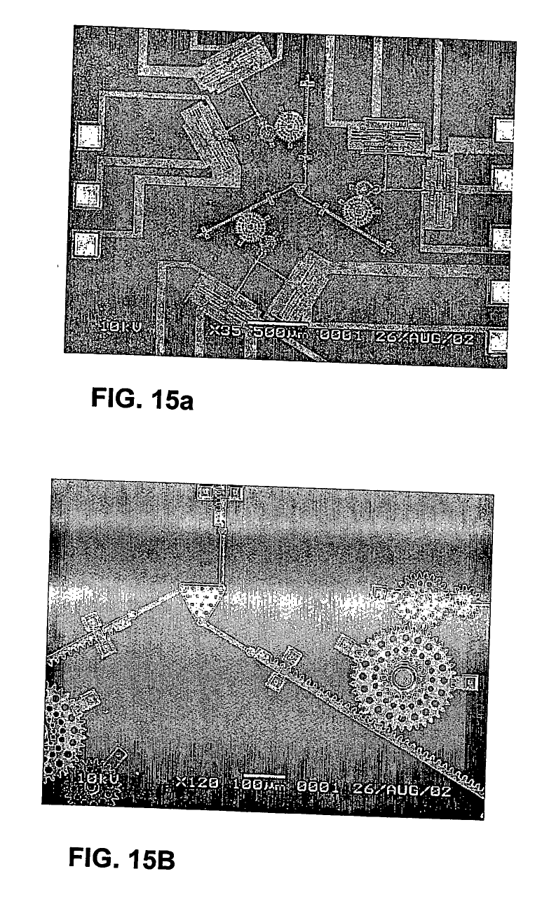

After the final HP release etched, the weight of the complete micro parallel mechanism is supported at the three pair of comb drives and the undersides of the six free joints, as shown in FIGS. 15a and 15b. These figures show the top view of the preferred mechanism model 10 after sacrificial oxide removal.

Various tools can be attached to the silicon platform 14 for broad range of applications. From an application perspective, various structures can possibly be built on the platform, including the following examples:

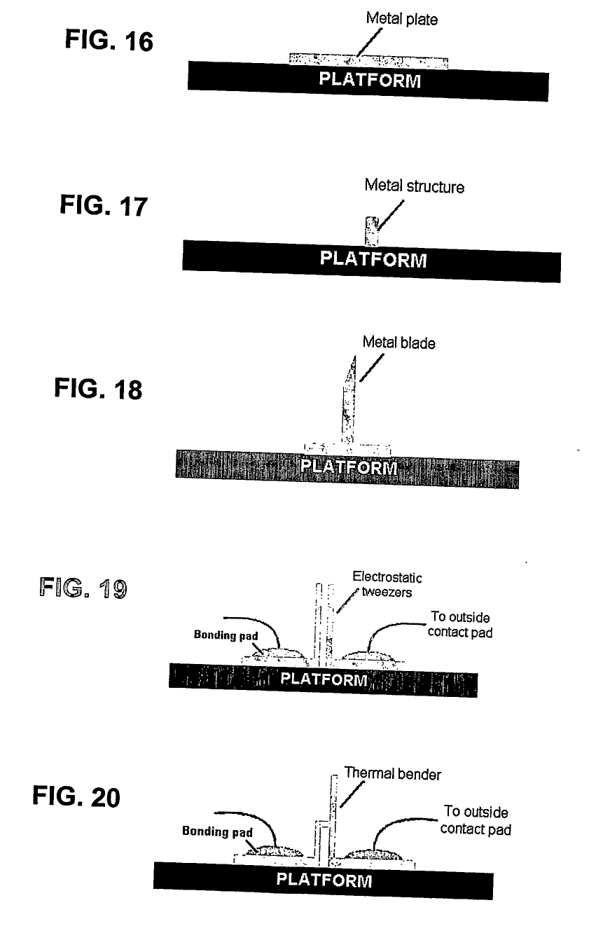

A mirror plate (FIG. 16) or metal plate/structure (FIG. 17) can be deposited and formed on the platform 14 by using various deposition processes with proper photolithography procedure. The material forming methods could be reactive ion beam (RIE) etching, inductively coupled plasma (ICP) etching or projections laser CVD. The focus ion beam (FIB) technique can be applied to modify and refine the surface topography to reach optical application requirements.

SU-8 photoresist is becoming a popular material for micro-tools or micro-molding structures patterning with high aspect ratio (more than 50 μm) microstructures by interacting with UV light source as PMMA photoresist used in the LIGA patterning process by X-ray source. Therefore, both SU-8 and LIGA pattern methods can be applied before the final PSGs release to generate micro-mold on the platform in this invention. Once the micro-molding concave is formed, the micro-electroplating technology that deposits nearly any common metal for various applications in today's microelectronics fabrication can be applied to generate the desired tool structure. The previously described lift-off process (FIG. 13) may be used for resist strip purposes, as shown in FIGS. 18, 19 and 20.

Except for the aforementioned mask pattern transfer method of FIGS. 9, 10, 11, 12, and 13 for the three-dimensional microfabrication, pattern-drawing methods, such as focused ion beam (FIB), can be employed as a post process to modify and refine the desired structure. For example, the FIB technology can be used to shape the desired tools as shown in FIG. 18 (metal blade). Other pattern drawing methods such as Laser-assisted CVD (LCVD), electron beam micromachining and other processes that can be used to grow three-dimensional microstructures onto a silicon platform with various materials could be integrated with the techniques disclosed herein. Wire bonding process can be applied to the outside contact pad for the electrical driving purpose with electrostatic tweezers (FIG. 19) and thermal bender (FIG. 20) being two examples.

Although limited embodiments of the micro parallel link mechanism systems have been specifically described and illustrated herein, many modifications and variations will be apparent to those skilled in the art, such as varying the dimensions of the linkages and gears, the number of teeth on each gear, the number of gears on each of the gear train, the shape and dimensions of the platform, the deposition material of the micromechanism structure, and tool attached on the platform. Accordingly, it is to be understood that the micro parallel link mechanism systems and their components constructed according to principles of this invention may be embodied other than as specifically described herein. The invention is defined in the following claims.

What is claimed is:

1. A micro parallel-link mechanism system comprising a first set of moving parts, said first set of moving parts comprising a gear train, a rack-and-pinion set, a strut coupled to a movable platform, and at least one comb actuator for supplying a force to the gear train; and wherein the first set of moving parts are fabricated from polysilicon material on one wafer using surface micromachining fabrication techniques.

2. The micro parallel-link mechanism system as recited in claim 1, wherein the movable platform is triangular in configuration.

3. The micro parallel-link mechanism system as recited in claim 2, wherein the movable platform comprises three vertices.

4. The micro parallel-link mechanism system as recited in claim 1, further comprising a second set of moving parts and a third set of moving parts.

5. The micro parallel-link mechanism system as recited in claim 1, further comprising a three-dimensional microstructure formed on the movable platform.

6. The micro parallel-link mechanism system as recited in claim 5, wherein the three-dimensional microstructure comprises a set of electrostatic tweezers.

7. The micro parallel-link mechanism system as recited in claim 5, wherein the three-dimensional microstructure comprises a thermal bender.

8. The micro parallel-link mechanism system as recited in claim 1, wherein the moving parts are fabricated by depositing a plurality of layers of polysilicon material.

9. The micro parallel-link mechanism system as recited in claim 1, wherein the moving parts are fabricated by depositing four layers of polysilicon material.

10. The micro parallel-link mechanism system as recited in claim 4, wherein the second and third sets of moving parts each comprises a gear train, a rack-and-pinion set, a strut coupled to a movable platform, and at least one comb actuator for supplying a force to the gear train.

11. The micro parallel-link mechanism system as recited in claim 10, wherein the three struts are each connected to the movable platform on a first end and to the rack on a second end.

12. The micro parallel-link mechanism system as recited in claim 11, wherein the movable platform and the three racks are positioned on approximately a same plane.

13. The micro parallel-link mechanism system as recited in claim 12, wherein the three struts are positioned on approximately a same plane above the plane comprising the movable platform.

14. The micro parallel-link mechanism system as recited in claim 4, wherein each set of moving parts comprises at least two comb actuators.

15. The micro parallel-link mechanism system as recited in claim 14, wherein the at least two comb actuators of each set of moving parts are connected to a gear of the gear train through linkages and through pin joints.

16. The micro parallel-link mechanism system as recited in claim 15, wherein each gear of the gear train comprises a retaining hub for attaching to a pin joint.

17. The micro parallel-link mechanism system as recited in claim 1, wherein the rack of the rack-and-pinion set and the gear of the gear train are supported by guide stoppers.

18. A micro parallel-link mechanism system comprising a plurality of interconnected parts including a movable platform connected to three struts, each strut being connected to a rack-and-pinion set, which is connected to a gear train, and which is connected to a pair of comb actuators, and wherein the plurality of interconnected parts are movable and produce a planar motion and rotation about an axis defined by the movable platform.

19. The micro parallel-link mechanism system as recited in claim 18, wherein the three struts are each connected to the movable platform by a pin joint.

20. The micro parallel-link mechanism system as recited in claim 18, wherein the three struts are each connected to a rack of the rack-and-pinion set, and wherein the connection between each strut and each rack comprises a pin joint.

21. The micro parallel-link mechanism system as recited in claim 18, wherein the gear train comprises at least one load gear and one output gear.

22. The micro parallel-link mechanism system as recited in claim 21, wherein the load gear has a root diameter that is larger than a root diameter of the output gear.

23. The micro parallel-link mechanism system as recited in claim 21, wherein the output gear is connected to the pair of comb actuators through a plurality of linkages and pin joints.

24. The micro parallel-link mechanism system as recited in claim 23, wherein the pair of comb actuators comprise a first actuator and a second actuator, and wherein:
(a) the first actuator is connected to a first linkage, which is connected to a second linkage by a first pin joint, where the second linkage is then connected to the output gear by a second pin joint, and
(b) the second actuator is connected to a third linkage, which is connected to the second linkage by a third pin joint, which is positioned between the first pin joint and the second pin joint.

25. The micro parallel-link mechanism system as recited in claim 18, wherein the movable platform is located a first plane, and wherein the three struts are located on a different plane.

26. The micro parallel-link mechanism system as recited in claim 25, wherein the plane with the three struts are above the plane with the platform.

27. The micro parallel-link mechanism system as recited in claim 18, further comprising a three-dimensional microstructure formed on the movable platform.

28. The micro parallel-link mechanism system as recited in claim 27, wherein the three-dimensional microstructure comprises a set of electrostatic tweezers.

29. The micro parallel-link mechanism system as recited in claim 28, wherein the three-dimensional microstructure comprises a thermal bender.

30. A method for forming a micro parallel-link mechanism system comprising a plurality of movable parts comprising a movable platform connected to a plurality of micro engines and micromechanisms comprising struts, gear trains, and rack-and-pinion sets, said method comprising the steps:
providing a silicon substrate;
applying a dielectric layer over the silicon substrate;
applying a plurality of masks for generating patterns for the plurality of movable parts; and
applying a plurality of polysilicon layers, patterning the polysilicon layers, and etching the polysilicon layers to form shapes of the plurality of movable parts.

31. The method for forming a micro parallel-link mechanism system as recited in claim 30, comprising more than four mask layers.

32. The method for forming a micro parallel-link mechanism system as recited in claim 31, comprising nine mask layers.

33. The method for forming a micro parallel-link mechanism system as recited in claim 30, comprising more than two polysilicon layers.

34. The method for forming a micro parallel-link mechanism system as recited in claim 33, comprising four polysilicon layers.

35. The method for forming a micro parallel-link mechanism system as recited in claim 30, further comprising the step of forming a three-dimensional microstructure on the movable platform.

36. The method for forming a micro parallel-link mechanism system as recited in claim 35, wherein the three-dimensional microstructure comprises a set of electrostatic tweezers.

37. The method for forming a micro parallel-link mechanism system as recited in claim 35, wherein the three-dimensional microstructure comprises a thermal bender.

38. The method for forming a micro parallel-link mechanism system as recited in claim 30, wherein the patterning step comprises photolithography patterning technique.

39. The method for forming a micro parallel-link mechanism system as recited in claim 30, wherein the etching step comprises reactive ion etching.

40. The method for forming a micro parallel-link mechanism system as recited in claim 30, further comprising a step of depositing a phosphosilicate glass layer over a first polysilicon layer.
